(19) United States
(12) Patent Application Publication
(10) Pub. No.: US 2008/0311993 A1
(43) Pub. Date: Dec. 18, 2008

(54) Device for generating control signals that can be evaluated electrically

(75) Inventors: Detlef Beutler, Weingarten (DE); Alfred Klein, Baienfurt (DE)

Correspondence Address: Pandiscio & Pandiscio, 470 Totten Pond Road, Waltham, MA, 02451, US

(73) Assignee: Rafi GmbH & Co. KG

(21) Appl. No.: 12/157,663

(22) Filed: Jun. 12, 2008

(30) Foreign Application Priority Data
Jun. 16, 2007 (EP) 07011844.3

(51) Int. Cl. G06F 17/00

(52) U.S. Cl. 463/38

(57) ABSTRACT

In a device (1) for generating control signals that can be evaluated electrically, which are generated by the manual actuation of a joystick (4) inserted in a housing (3) of the device (1) and which can be deflected in various movement directions, it is intended to ensure that exclusively intended control movements of the joystick are transferred without imposing any physical strain on the user when the user operates the joystick. Furthermore, the operating safety of the device or the electrical circuit should be capable of being checked and guaranteed throughout the entire service life. This task is accomplished in that one or more sensor switches (11) are integrated in the outer jacket surface of the joystick (4), each of these can trigger a check signal (13) and the device (1) can be activated by the check signal (13) or check signals (13).

The present invention relates to a device for generating control signals that can be evaluated electrically in accordance with the precharacterising clause of patent claim 1 as well as to an electrical circuit for generating electrical control signals in accordance with the precharacterising clause of patent claim 6.

Devices or a circuit of this kind normally consist of a manually operated joystick inserted in a housing which can be deflected in various movement directions. This involves gripping the free end of the joystick with the hand, whilst the movements of the joystick in the housing are converted into electrical signals by, for example, Hall sensors. The electrical signals are evaluated by a circuit board including a microprocessor or similar control circuitry and consequently the movement directions of the joystick can be converted into electrical signals, for example for deflecting a crane or other technical equipment as well as for operating a computer that is operated by means of control signals that are assigned to various control signals on the screen.

Normally, there is a button provided on the free end of the joystick which must be kept permanently pressed in order to enable the deflection of the joystick to be converted into movement directions at all. This button is used for operating safety of the joystick, by ensuring that inadvertent deflection of the joystick does not result in any movements of the systems to be driven, and therefore rules out an incorrect operation.

The present state of the art has proven to suffer from the disadvantage that the button which has to be kept permanently pressed imposes an ergonomic strain leading to tension building up in the user after a certain period of time and this tension has a negative effect on the movement sequences and fine motor skills of the user.

It is therefore the task of the present invention to design a device or an electrical circuit of the aforementioned kind which guarantees that exclusively intentional control movements are transmitted by the joystick without imposing a physical strain on the user whilst the joystick is being used. In addition, the operating safety of the device or the electrical circuit should be capable of being checked and guaranteed throughout the entire service life. This task is accomplished in the present invention by features of the precharacterising part of patent claims 1 and 6.

Further advantageous embodiments of the present invention are disclosed in the subordinate claims.

One or more sensor switches, configured to operate capacitively or optically, are integrated in the outer jacket surface of the joystick, thereby allowing diverse check signals to be generated by means of which the function of the joystick is monitored, because the device is exclusively enabled when the check signals are present. In the capacitive version of the sensor switch, the control signals are generated when the palm of the user's hand induces a capacitive change in the metallic sensor switches, thus giving rise to the check signal. Each of the sensor switches is connected to an evaluation unit that monitors whether a check signal is generated by the sensor circuit or not. Accordingly, if a user touches the joystick inadvertently and causes it to deflect then this deflection of the joystick is not converted into a movement of the system because the evaluation unit does not receive any check signal with the effect that the device as a whole is not activated.

If, one the other hand, the user grips the joystick in the correct manner, then each of the sensor switches will be covered by the user's palm. In the capacitive version of the sensor switch, therefore, the gripping of the joystick causes a change in capacity. If the sensor switch is configured as a light barrier then the user's hand reflects the emitted light, meaning that permanent monitoring is also provided for the gripping area of the joystick, although by light sensors in this case.

Furthermore, the evaluation unit can generate a signal independently that makes it possible to check that the evaluation unit is functioning correctly. As soon as the evaluation unit ceases to function, whether because of malfunctions or other damage, then this signal is not generated either, with the effect that incorrect operation due to the evaluation unit having suffered damaged cannot take place because the device is only fully activated if both the check signal from the particular sensor switch and the signal from the particular evaluation unit are present. Signals generated in this way are transferred to the circuit board integrated in the housing of the joystick and are evaluated by a microprocessor on the circuit board or other control circuitry.

Initially, therefore, there is a check that, firstly, an intended operation of the joystick has taken place and that, secondly, the evaluation unit is functioning correctly. Only when all signals are present is the device, and therefore the possibility of the device to be moved by the joystick being moved, enabled.

The drawing shows two sample embodiments as well as various embodiment versions of joysticks configured in accordance with the present invention, the details of which are explained below. In the drawing,

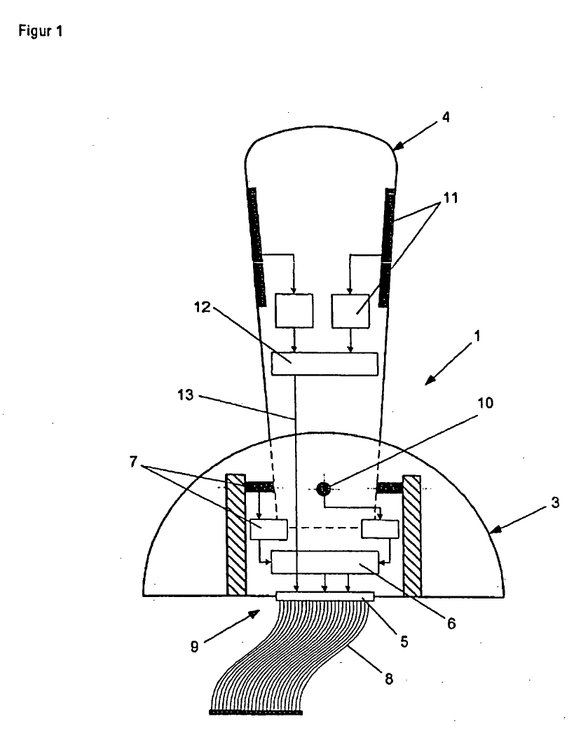

FIG. 1 shows a first sample embodiment of a device for generating signals that can be evaluated electrically, consisting of a joystick that can be deflected and is inserted in a housing, as well as evaluation electronics that process the movement direction of the joystick, in a sectional view,

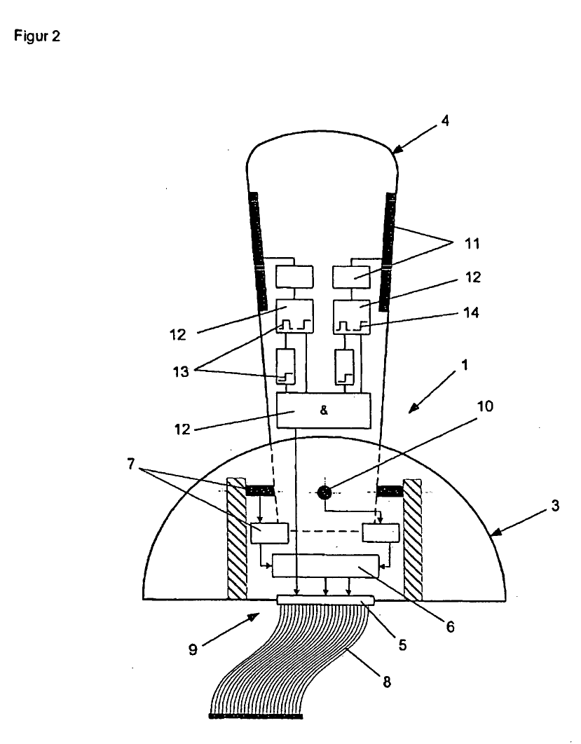

FIG. 2 shows a second sample embodiment of a device for generating signals that can be evaluated electrically, consisting of a joystick that can be deflected and is inserted in a housing, as well as evaluation electronics that process the movement direction of the joystick, in a sectional view,

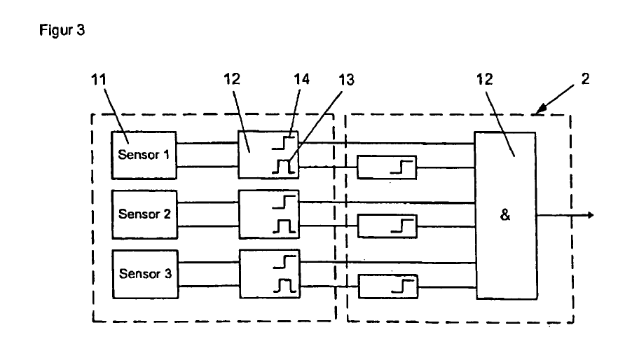

FIG. 3 shows an electrical circuit for the device shown in FIG. 2,

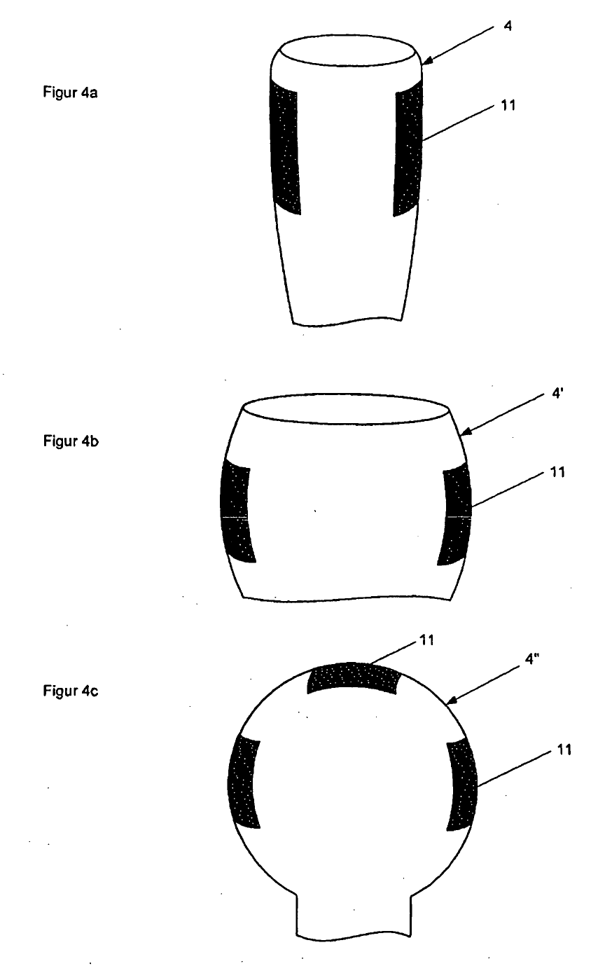

FIG. 4a shows a first variant of an embodiment for a joystick,

FIG. 4b shows a second variant for the embodiment of a joystick and

FIG. 4c shows a third variant for the embodiment of a joystick, in each case in a sectional view.

FIGS. 1 and 2 show a device 1 consisting of a housing 3 and a joystick 4 inserted in the housing 3 and which can be deflected in relation to the housing 3. As such, the device 1 should convert the manual movements applied to the joystick 4 into control signals that can be evaluated electrically in order to control a crane system, a cursor on a computer screen or other machinery by means of these control signals.

FIG. 1 shows that the joystick 4 is supported in a schematically embodied bearing 10 with the effect that the joystick 4 can perform a rotary movement about the bearing 10 and be deflected in two tilting movements in the X and Y direction which together form one plane. These movements of the joystick 4 are measured by commercially available Hall sensors 7, because the Hall sensors are structured in such a way that a first part of the particular Hall sensor 7 is firmly connected to the joystick 4 whereas a second part of the Hall sensor 7 is firmly integrated in the housing 3 and therefore relative movements between the two parts of the Hall sensor 7, which correspond to the deflection of the joystick 4, can be measured. The control signals generated by the Hall sensors 7 in this way are transferred to a microprocessor 6 that is electrically connected to a circuit board 5. The circuit board 5 and the microprocessor 6 are also firmly installed in the housing. The evaluation programs uploaded onto the microprocessor 6 consequently convert the movements from the Hall sensor 7 into electrical control signals, by means of which a crane system, for example, or a cursor on a computer screen can be moved in corresponding directions. These control systems are transferred to the corresponding system by means of a plurality of cables 8 that are connected to the circuit board 5 via an interface 9.

To preclude malfunctions during the operation of the joystick 4, in particular due to inadvertently knocking the joystick 4, which could have serious effects on the operational safety of the machinery to be controlled with the joystick 4, two schematically represented sensor switches 11 are provided in the handle part, i.e. in the free end of the joystick 4. The sensor switches 11 consist of a light-permeable or metallic plate that is integrated in the outer jacket surface of the joystick 4. If a metallic plate is used as the sensor switch 11 then the capacitive changes induced when the joystick 4 is gripped by the user's hand are measured. These capacitive changes are measured by an electrical evaluation unit, resulting in a check signal 13.

If the sensor switch 11 is a light-permeable plate then one or more light-emitting diodes emits light waves which penetrate the light-permeable plate of the sensor switch 11 but, when the user's hand is gripping the joystick 4, they are reflected back. These reflections can also be measured by evaluation electronics and, as a result, check signals 13 are generated.

Both these embodiments guarantee permanent monitoring of whether or not the joystick 4 is being gripped correctly by hand, and in other words whether the deflection of the joystick 4 is defined and intended. The check signals 13 generated by each of the sensor switches 11 are transferred electrically to an evaluation unit 12 installed in the joystick 4. The evaluation unit 12 measures whether all sensor switches 11 integrated in the joystick 4 are delivering an appropriate check signal 13 and only when the check signals 13 from all built-in sensor switches 11 are picked up by the evaluation unit 12 does the evaluation unit 12 enable the circuit board 5 and/or microprocessor 6, with the effect that the movements transmitted from the joystick 4 are passed on to the machinery.

If, on the other hand, the joystick 4 is not gripped correctly, for example if someone's forearm merely knocks against one of the sensor switches 11, then the evaluation unit 12 does not enable the circuit board 5 or microprocessor 6, with the effect that the deflections of the joystick 4 generated in this way are not passed on to the machinery. This means the machinery is only operable when the evaluation unit 12 detects an appropriate check signal 13. This means the more sensors switches 11 are installed in the joystick 4, the greater the accuracy, meaning that the mis-triggering quota for inadvertent operation of the joystick 4 is avoided.

FIG. 2 shows a further technical development of the device 1 explained in FIG. 1, in order to avoid additional malfunctions such as if the electronics of the evaluation unit 12 were to be damaged. For this purpose, it is not only a check signal 13 that is transferred from the respective sensor switches 11 to the evaluation unit 12, but also each of the evaluation units 12 is assigned to a particular sensor switch 11 and are electrically connected to it. At the same time, the particular evaluation unit 12 generates a measuring signal 14 that is also picked up by a second evaluation unit 12. If the second evaluation unit 12 receives not only the check signal 13 but also the measuring signal 14 from the first evaluation unit 12, and this applies to all first evaluation units 12 integrated in the joystick 4, then the circuit board 5 and/or the microprocessor 6 is enabled in order to convert the deflection movements of the joystick 4 into electrical control signals, and to transfer these to the machinery via the Interface 9.

The circuit diagram shown in FIG. 3 relates to an electrical circuit 2 that can be used for a total of three sensor switches 11 installed in the joystick 4. The method of function and design configuration corresponds to the sample embodiment explained in FIG. 2. The first evaluation unit 12 therefore picks up the check signal 13 that is generated by the particular sensor switch 11 when the joystick 4 is gripped correctly. At the same time, the first evaluation unit 12 generates the measuring signal 14. Both signals are picked up by the second evaluation unit 12 and, when this unit has determined that all check signals 13 and measuring signals 14 are present, the switching of circuit 2 is enabled.

FIGS. 4a, 4b and 4c show a schematic view of different variants of the embodiment in terms of the shape of the joystick 4 according to its function. However, the method of function and the described safety setting for the deflection of the particular joystick 4, 4′ or 4″ should be identical.

The joystick 4 is chiefly moved in one plane out of a middle position and, if necessary, can also be rotated about a fixed bearing point.

The joystick 4′ in FIG. 4b should also enable movement in the direction of the housing 3 in addition to the functions of the joystick 4 in FIG. 4a, for example in order to signal an input confirmation for the control movements or to perform a movement procedure by entering a defined control command in the direction of the housing 3.

The joystick 4″ shown in FIG. 4c is spherical in shape and has a total of three sensor switches 11 which are aligned at right angles or flush with one another. The joystick 4″ is not only intended to be moved in one plane and about its bearing point but also allow movement in other degrees of freedom, for example at right angles relative to the housing 3.

What is claimed is:

1. A device (1) for generating control signals that can be evaluated electrically and can be generated by manual actuation of a joystick (4, 4′, 4″) mounted in a housing (3) of the device (1), and which can be deflected in various movement directions, wherein at least one sensor switch (11) is integrated in the outer surface of the joystick (4, 4′, 4″), by means of which a check signal (13) can be triggered when the joystick (4, 4′, 4″) is gripped, and wherein the check signal (13) allows the device (1) to be activated.

2. The device in accordance with claim 1, wherein at least one evaluation unit (12) is electrically connected to the sensor switch (11) and the evaluation unit (12) allows the device (1) to be activated in accordance with the check signals (13) generated by the sensor switch (11).

3. The device in accordance with claim 2, wherein the evaluation unit (12) is connected to at least one of a circuit board (5) and a microprocessor (6), and the evaluation unit (12) enables the circuit board (5) and/or the microprocessor (6) to be controlled in such a way that the circuit board (5) and/or the microprocessor (6) are enabled when a check signal (13) is present.

4. The device in accordance with claim 1, wherein the sensor switches (11) is configured as a selected one of a capacitive metal plate and a light-permeable plate with light-emitting diodes and light wave detectors.

5. The device in accordance with claim 2, wherein a measuring signal (14) can be generated by the evaluation unit (12), and each measuring signal (14) is transferable to the circuit board (5) and/or the microprocessor (6) for checking the function of the evaluation unit (12).

6. An electrical circuit (2) for creating electrical control signals generated by manual actuation of a joystick (4, 4′, 4″) mounted in a housing (3) of a device (1) and can be deflected in various movement directions, wherein at least one sensor switches (11) is assigned to the joystick (4, 4′, 4″), and is adapted to generate a check signal (13) when the joystick (4, 4′, 4″) is gripped, and the check signal (13) is transferred to an evaluation unit (12) installed in the joystick (4, 4′, 4″) and the device (1) is adapted to be activated by the evaluation unit (12).
